(19) United States
(12) Patent Application Publication
(10) Pub. No.: US 2010/0156295 A1
(43) Pub. Date: Jun. 24, 2010

(54) ELECTRODELESS BULB, AND ELECTRODELESS LIGHTING SYSTEM HAVING THE SAME

(76) Inventors: Kyung-Hoon Park, Changwon (KR); Tae-Ho Lee, Gumi (KR)

Correspondence Address: BIRCH STEWART KOLASCH & BIRCH, PO BOX 747, FALLS CHURCH, VA, 22040-0747, US

(21) Appl. No.: 12/513,115

(22) PCT Filed: Oct. 31, 2006
(86) PCT No.: PCT/KR2006/004474

§ 371 Date: Mar. 10, 2010

(51) Int. Cl. H01J 7/46; H01J 61/00; H01J 61/12

(52) U.S. Cl. 315/39; 313/567; 313/643

(57) ABSTRACT

Disclosed are an electrodeless bulb (10), and an electrodeless lighting system having the same. The electrodeless bulb (10) includes; a light emitting unit (11, 13) having an airtight inside space (116, 13a); a main discharge material filled in the inside space (11a, 13a) of the light emitting unit (11, 13) and discharged by microwave, for emitting light; a discharge assistant material filled in the light emitting unit (11, 13), for forming plasma in the inside space (11a, 13a) before the main discharge material generates plasma; and a discharge catalyst material filled in the light emitting unit (11, 13), for inducing initial discharge of the main discharge material and the discharge assistant material. The lighting system improves lighting efficiency of the main discharge material filled in the light emitting unit (11, 13), and has an eco-friendly characteristic by excluding an environmental contaminant such as mercury.

### TECHNICAL FIELD

The present invention relates to an electrodeless lighting system using microwave discharge, and more particularly, to an electrodeless bulb, and an electrodeless lighting system having the same which can facilitate initial lighting by forming an auxiliary light emitting unit containing a discharge assistant material and a discharge catalyst material near a light emitting unit of the electrodeless bulb.

### BACKGROUND ART

In general, an electrodeless lighting system (plasma lighting system) uses a magnetron. Microwave generated by the magnetron discharges a discharge material in an electrodeless bulb to form a plasma state, and makes a metallic compound continuously emit light, so that the electrodeless lighting system can supply high intensity light without an electrode.

A main discharge material for leading light emission by forming plasma in the operation, such as metal, halogen compound, sulfur, selenium or the like, a discharge assistant material for forming plasma in a light emitting unit at the initial stage of light emission, such as an inert gas Ar, Xe, Kr or the like, and a discharge catalyst material for easing lighting by helping initial discharge or adjusting a spectrum of the generated light, such as mercury are filled in the electrodeless bulb of the electrodeless lighting system.

FIG. 1 is a cross-sectional view illustrating a conventional electrodeless lighting system.

Referring to FIG. 1, the conventional electrodeless lighting system includes a magnetron 2 mounted in a casing 1, for generating microwave, a high voltage generator 3 for boosting common AC power to a high voltage, and supplying the high voltage to the magnetron 2, a waveguide 4 connected to an outlet unit of the magnetron 2, for transmitting the microwave generated by the magnetron 2, an electrodeless bulb 5 filled with the main discharge material, the discharge assistant material and the discharge catalyst material, for emitting light as the filled material generates plasma by the microwave transmitted through the waveguide 4, a resonator 6 covered on the front portions of the waveguide 4 and the electrodeless bulb 5, for resonating the microwave with a predetermined resonating frequency, a reflecting shade 7 for housing the resonator 6, and intensively reflecting the light generated by the electrodeless bulb 5 straight, a reflector 8 mounted in the resonator 6 and positioned at the rear side of the electrodeless bulb 5, for transmitting the microwave supplied through the waveguide 4, and reflecting the light generated by the electrodeless bulb 5, and a cooling fan 9 disposed at one side of the casing 1, for cooling the magnetron 2 and the high voltage generator 3.

The electrodeless bulb 5 includes a light emitting unit 5a made of quartz in a globular shape with an inside space, and disposed outside the casing 1, and a supporting unit 5b formed in a rod shape extended from the light emitting unit 5a, for supporting the light emitting unit 5a in the casing 1.

The main discharge material, the discharge assistant material and the discharge catalyst material are filled in the inside space of the light emitting unit 5a under a predetermined pressure, for generating plasma and emitting light.

The supporting unit 5b is coupled to a rotation shaft of a bulb motor M installed in the casing 1 through the reflector 8.

Reference numeral 8a denotes a bulb through hole, and M2 denotes a fan motor for rotating the cooling fan 9.

The operation of the conventional electrodeless lighting system will now be described.

When a driving signal is inputted to the high voltage generator 3 according to a command of a control unit, the high voltage generator 3 boosts AC power and supplies the high voltage to the magnetron 2, and the magnetron 2 generates microwave having a very high frequency by the high voltage. The microwave is resonated in the resonator 6 through the waveguide 4, for discharging the main discharge material filled in the electrodeless bulb 5. When the main discharge material is excited to generate plasma, light is generated with an intrinsic discharge spectrum. The light is reflected to the front by the reflecting shade 7 and the reflector 8, thereby lightening the space.

The discharge assistant material filled in the light emitting unit 5a with the main discharge material is discharged before the main discharge material is discharged by the microwave, thereby generating plasma in the light emitting unit 5a. The discharge catalyst material also filled in the light emitting unit 5a serves to rapidly discharge the main discharge material or the discharge assistant material at the initial stage of lighting.

As described above, the conventional electrodeless lighting system has employed mercury as the discharge catalyst material. As mercury turns out to be an environmental contaminant, efforts have been made not to use mercury. However, if mercury is not used as the discharge catalyst material, initial discharge of the filled material is delayed, and if intensity of an externally-applied electric field is not uniform, a discharge error occurs. As a result, reliability of the electrodeless lighting system is seriously reduced.

### DISCLOSURE OF THE INVENTION

Therefore, an object of the present invention is to provide an electrodeless bulb, and an electrodeless lighting system having the same which can easily and uniformly carry out initial discharge without using an environmental contaminant such as mercury.

To achieve these and other advantages and in accordance with the purpose of the present invention, as embodied and broadly described herein, there is provided an electrodeless bulb, including: a light emitting unit having an airtight inside space; a main discharge material filled in the inside space of the light emitting unit and discharged by microwave, for emitting light; a discharge assistant material filled in the light emitting unit, for forming plasma in the inside space before the main discharge material generates plasma; and a discharge catalyst material filled in the light emitting unit, for inducing initial discharge of the main discharge material and the discharge assistant material.

According to another aspect of the present invention, there is provided an electrodeless bulb, including: a light emitting unit having an airtight inside space filled with a discharge material, and emitting light as the discharge material is discharged by microwave to generate plasma; and an auxiliary light emitting unit formed outside the light emitting unit with an airtight inside space, a discharge assistant material being filled in the inside space, for forming plasma in the inside space of the light emitting unit before the discharge material of the light emitting unit is discharged.

According to yet another aspect of the present invention, there is provided an electrodeless lighting system, including: a magnetron mounted in a casing, for generating microwave; a waveguide connected to an outlet unit of the magnetron, for transmitting the microwave generated by the magnetron; an electrodeless bulb including a light emitting unit having an airtight inside space filled with a discharge material, and emitting light as the discharge material is discharged by the microwave to generate plasma, and a supporting unit extended from the outer circumference of the light emitting unit; a resonator housing the electrodeless bulb and being connected to an outlet of the waveguide, the resonator resonating the microwave transmitted through the waveguide with a predetermined resonating frequency; and a reflector mounted in the resonator, for transmitting the light generated by the electrodeless bulb, the supporting unit of the electrodeless bulb passing through the reflector, wherein an auxiliary light emitting unit having an airtight inside space is formed outside the light emitting unit of the electrodeless bulb, and filled with a discharge assistant material for forming plasma in the inside space of the light emitting unit before the discharge material of the light emitting unit is discharged.

In accordance with the present invention, the discharge assistant material and the discharge catalyst material are filled in the inside space of the light emitting unit and the inside space of the auxiliary light emitting unit formed on the outer circumference of the light emitting unit. Accordingly, the discharge assistant material and the discharge catalyst material are rapidly discharged by the electric field formed in the resonator, which eases initial lighting of the main discharge material of the light emitting unit and reduces the lighting time of the light emitting unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view illustrating a conventional electrodeless lighting system having an electrodeless bulb;

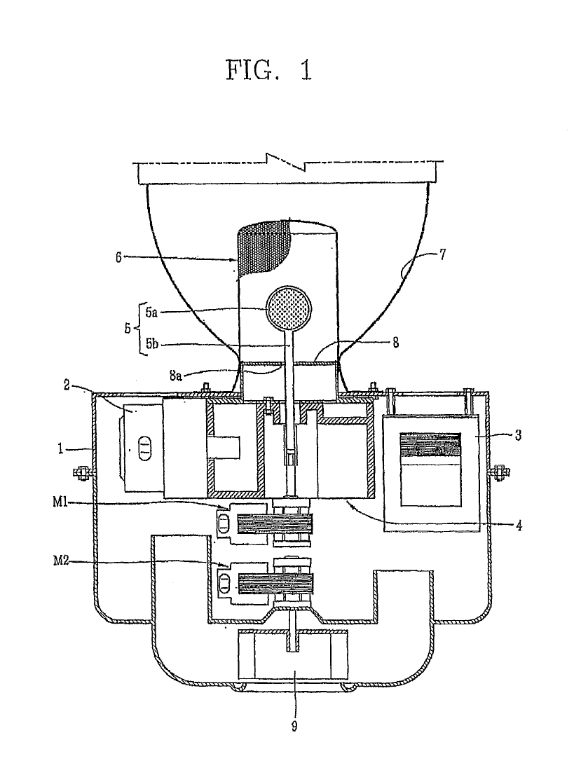

FIG. 2 is a cross-sectional view illustrating an electrodeless lighting system having an electrodeless bulb in accordance with a first embodiment of the present invention;

FIG. 3 is a cross-sectional view illustrating an electrodeless lighting system having an electrodeless bulb in accordance with a second embodiment of the present invention;

FIG. 4 is a cross-sectional view illustrating one example of the electrodeless bulb in accordance with the second embodiment of the present invention;

FIG. 5 is a cross-sectional view illustrating a modified example of the electrodeless bulb in accordance with the second embodiment of the present invention;

FIG. 6 is a cross-sectional view illustrating another modified example of the electrodeless bulb in accordance with the second embodiment of the present invention;

FIG. 7 is a cross-sectional view illustrating yet another modified example of the electrodeless bulb in accordance with the second embodiment of the present invention; and

FIG. 8 is a cross-sectional view illustrating yet another modified example of the electrodeless bulb in accordance with the second embodiment of the present invention.

### MODES FOR CARRYING OUT THE PREFERRED EMBODIMENTS

Reference will now be made in detail to the preferred embodiments of the present invention, examples of which are illustrated in the accompanying drawings.

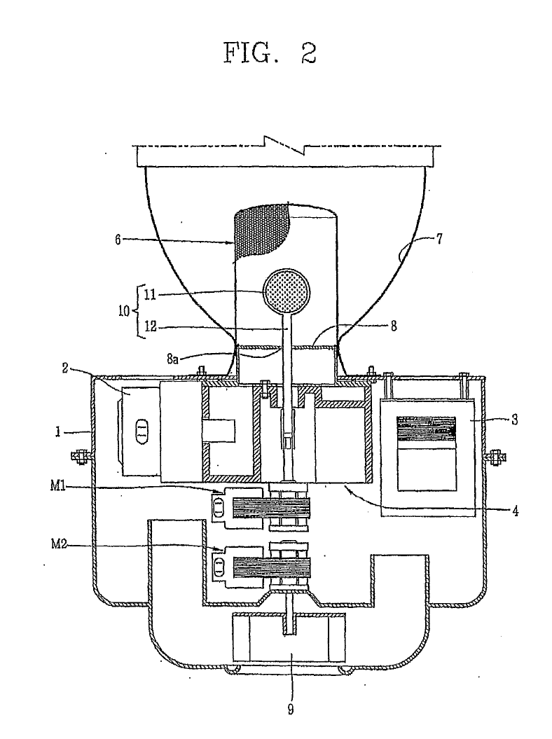

FIG. 2 is a cross-sectional view illustrating an electrodeless lighting system having an electrodeless bulb in accordance with a first embodiment of the present invention.

As illustrated in FIG. 2, the electrodeless lighting system includes a magnetron 2 mounted in a casing 1, for generating microwave, a waveguide 4 connected to an outlet unit of the magnetron 2, for transmitting the microwave generated by the magnetron 2, an electrodeless bulb 10 for emitting light as plasma is generated by the microwave transmitted through the waveguide 4, a resonator 6 covered on the front portions of the waveguide 4 and the electrodeless bulb 10, for resonating the microwave with a predetermined resonating frequency, a reflecting shade 7 for housing the resonator 6, and intensively reflecting the light generated by the electrodeless bulb 10 straight, a reflector 8 mounted in the resonator 6 and positioned at the rear side of the electrodeless bulb 5, for reflecting the light generated by the electrodeless bulb 5, and a cooling fan 9 disposed at one side of the casing 1, for cooling the magnetron 2 and a high voltage generator 3.

The resonator 6 is formed in a mesh shape to block the microwave and transmit the light emitted from the electrodeless bulb 10. The reflector 8 is made of a disc-shaped dielectric, for transmitting the microwave supplied through the waveguide 4, and reflecting the light generated by the electrodeless bulb 10. A bulb through hole 8a is formed at the center of the reflector 8, so that a supporting unit 12 of the electrodeless bulb 10 can pass through the bulb through hole 8a.

The electrodeless bulb 10 includes a light emitting unit 11 formed in a globular or cylindrical shape with an inside space 11a, and disposed outside the casing 1, and a supporting unit 12 formed in a rod shape extended from the light emitting unit 11, for supporting the light emitting unit 11 in the casing 1.

The light emitting unit 11 is made of quartz showing high optical transmissivity and low dielectric loss. A main discharge material and a discharge assistant material, or the main discharge material, the discharge assistant material and a discharge catalyst material except mercury are filled in the inside space 11a of the light emitting unit 11.

Sulfur, halogen compound or selenium is used as the main discharge material.

An inert gas such as Ar, Xe or Kr is used as the discharge assistant material.

A metal material which can generate an arc by reflecting the microwave or radiate electrons by itself can be used as the discharge catalyst material. Generally, the metal material contains at least one of W, Re, Ta, Ba, Sb, In, Cd, Zn, Ge, As, Tl, Bi, Sc, Ti and Zr.

In addition, Ne can be used as the discharge catalyst material. Preferably, a mixture rate of Ne ranges from 30 to 50% of the discharge assistant material to improve efficiency of light emission.

Same drawing reference numerals are used for the same elements even in different drawings.

The operation of the electrodeless lighting system in accordance with the present invention will now be described.

According to a command of a control unit, the magnetron 2 is operated to generate microwave having a very high frequency. The microwave is radiated to the resonator 6 through the waveguide 4, for forming a strong electric field. As the main discharge material and the discharge assistant material filled in the inside space 11a of the light emitting unit 11 of the electrodeless bulb 10 are excited to continuously generate plasma, light is generated with an intrinsic discharge spectrum. The light is reflected to the front by the reflecting shade 7 and the reflector 8, thereby lightening the space.

If the metal having high microwave reflection performance and self electron radiation performance, or a mixture of Ne and Ar for facilitating initial discharge is filled in the inside space 11a of the light emitting unit 11 of the electrodeless bulb 10, a success ratio of initial lighting considerably increases. Especially, when Ne and Ar are mixed, atom generation possibility of Ne and Ar increases. Therefore, lighting efficiency can be more improved by using UV energy generated by Ne.

In the above embodiment, the discharge assistant material and the discharge catalyst material have been filled in the light emitting unit 11 of the electrodeless bulb 10. In this embodiment, an auxiliary light emitting unit 13 having an airtight inside space 13a is formed outside the light emitting unit 11, and the discharge assistant material and the discharge catalyst material are filled in the inside space 13a of the auxiliary light emitting unit 13.

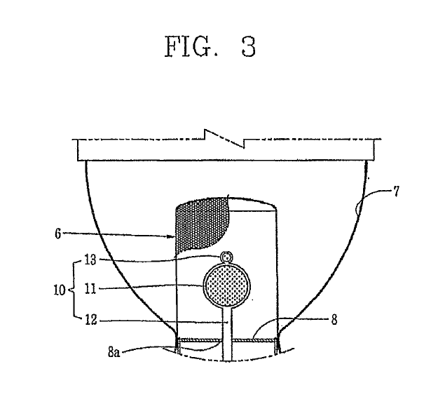

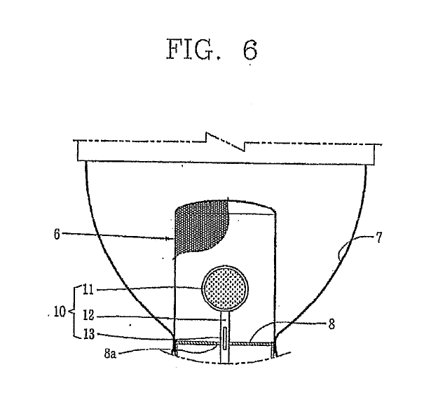

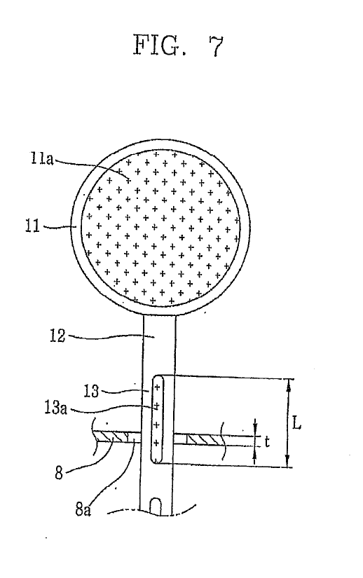

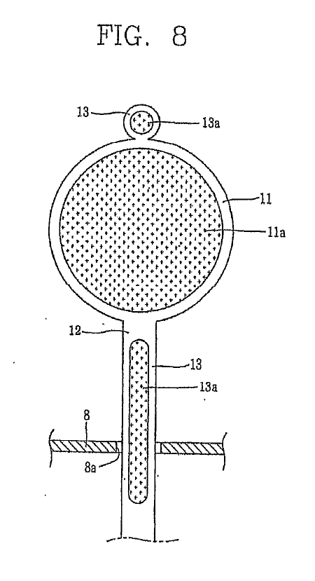

As illustrated in FIGS. 3 to 5, the auxiliary light emitting unit 13 can be formed on the outer circumference of the light emitting unit 11. As shown in FIGS. 6 and 7, the auxiliary light emitting unit 13 can be formed in the supporting unit 12. As shown in FIG. 8, the auxiliary light emitting unit 13 can be formed in the light emitting unit 11 and the supporting unit 12, respectively. In addition, the auxiliary light emitting unit 13 can be incorporated or assembled with the light emitting unit 11 or the supporting unit 12.

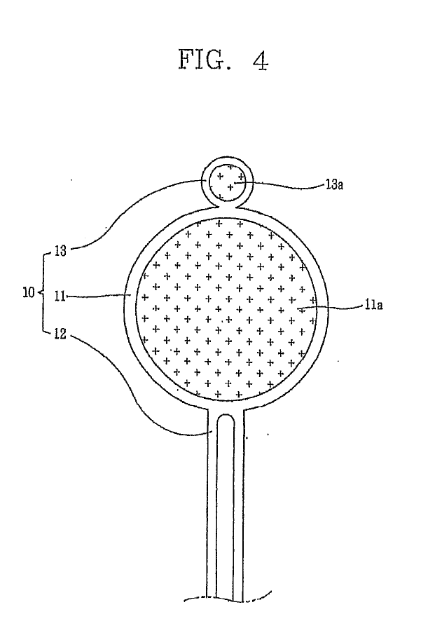

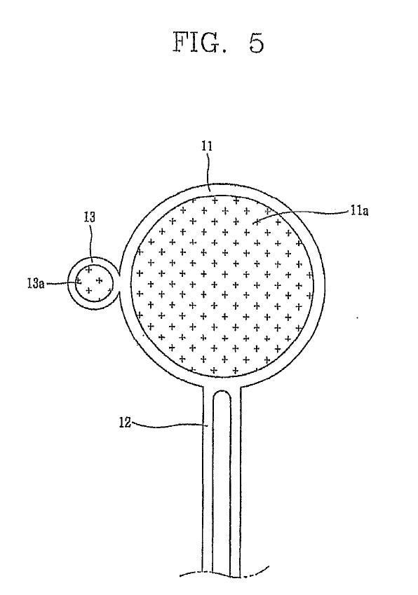

In the case that the auxiliary light emitting unit 13 is formed on the outer circumference of the light emitting unit 11, as shown in FIG. 4, the auxiliary light emitting unit 13 can be positioned in a straight line from the supporting unit 12 by considering eccentricity in rotation of the electrodeless bulb 10, and as shown in FIG. 5, the auxiliary light emitting unit 13 can be positioned within ±180° (+90° in the drawing) from the supporting unit 12 by considering light shading to the light emitting unit 11.

When the auxiliary light emitting unit 13 is formed in the supporting unit 12, as shown in FIG. 6, the auxiliary light emitting unit 13 is formed at the middle portion of the supporting unit 12 to overlap with the bulb through hole 8a of the reflector 8, so that a strong electric field can be concentrated on the auxiliary light emitting unit 13. The length L of the auxiliary light emitting unit 13 is larger than the thickness t of the reflector 8.

As depicted in FIG. 8, the auxiliary light emitting unit 13 can be formed on the boundary between the light emitting unit 11 and the supporting unit 12.

The main discharge material, the discharge assistant material and the discharge catalyst material of this embodiment are identical to those of the above-described embodiment, and thus detailed explanations thereof are omitted.

In the electrodeless lighting system, since the discharge assistant material and the discharge catalyst material are also filled in the inside space 13a of the auxiliary light emitting unit 13 formed on the outer circumference of the light emitting unit 11, the discharge assistant material and the discharge catalyst material are rapidly discharged by the electric field generated in the resonator 6. Accordingly, initial lighting of the main discharge material of the light emitting unit 11 is facilitated, and the lighting time of the light emitting time 11 is shortened. Especially, when the auxiliary light emitting unit 13 is formed around the bulb through hole 8a of the reflector 8, the discharge assistant material and the discharge catalyst material filled in the inside space 13a of the auxiliary light emitting unit 13 formed in the supporting unit 12 are rapidly discharged by the strong electric field formed on the bulb through hole 8a, thereby remarkably reducing the lighting time of the light emitting unit 11.

The present invention provides the eco-friendly lighting system having high optical efficiency, by rapidly performing the initial lighting or re-lighting without using mercury.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An electrodeless bulb, comprising:
a light emitting unit having an airtight inside space;
a main discharge material filled in the inside space of the light emitting unit and discharged by microwave, for emitting light;
a discharge assistant material filled in the light emitting unit, for forming plasma in the inside space before the main discharge material generates plasma; and
a discharge catalyst material filled in the light emitting unit, for inducing initial discharge of the main discharge material and the discharge assistant material.

2. The electrodeless bulb as claimed in claim 1, wherein the discharge catalyst material is metal.

3. The electrodeless bulb as claimed in claim 2, wherein the metal comprises at least one of W, Re, Ta, Ba, Sb, In, Cd, Zn, Ge, As, Tl, Bi, Sc, Ti and Zr.

4. The electrodeless bulb as claimed in claim 1, wherein the discharge catalyst material is Ne.

5. The electrodeless bulb as claimed in claim 1, wherein metal and Ne are filled as the discharge catalyst material.

6. An electrodeless bulb, comprising:
a light emitting unit having an airtight inside space filled with a discharge material, and emitting light as the discharge material is discharged by microwave to generate plasma; and
an auxiliary light emitting unit formed outside the light emitting unit with an airtight inside space, a discharge assistant material being filled in the inside space, for forming plasma in the inside space of the light emitting unit before the discharge material of the light emitting unit is discharged.

7. The electrodeless bulb as claimed in claim 6, wherein the discharge assistant material is Ar.

8. The electrodeless bulb as claimed in claim 6, wherein a discharge catalyst material for inducing initial discharge of the discharge assistant material is filled in the auxiliary light emitting unit.

9. The electrodeless bulb as claimed in claim 8, wherein the discharge catalyst material is metal.

10. The electrodeless bulb as claimed in claim 9, wherein the metal comprises at least one of W, Re, Ta, Ba, Sb, In, Cd, Zn, Ge, As, Tl, Bi, Sc, Ti and Zr.

11. The electrodeless bulb as claimed in claim 8, wherein the discharge catalyst material is Ne.

12. The electrodeless bulb as claimed in claim 8, wherein metal and Ne are filled as the discharge catalyst material.

13. An electrodeless lighting system, comprising:
a magnetron mounted in a casing, for generating microwave;
a waveguide connected to an outlet unit of the magnetron, for transmitting the microwave generated by the magnetron;
an electrodeless bulb including a light emitting unit having an airtight inside space filled with a discharge material, and emitting light as the discharge material is discharged by the microwave to generate plasma, and a supporting unit extended from the outer circumference of the light emitting unit;
a resonator housing the electrodeless bulb and being connected to an outlet of the waveguide, the resonator resonating the microwave transmitted through the waveguide with a predetermined resonating frequency; and
a reflector mounted in the resonator, for transmitting the light generated by the electrodeless bulb, the supporting unit of the electrodeless bulb passing through the reflector,
wherein an auxiliary light emitting unit having an airtight inside space is formed outside the light emitting unit of the electrodeless bulb, and filled with a discharge assistant material for forming plasma in the inside space of the light emitting unit before the discharge material of the light emitting unit is discharged.

14. The electrodeless lighting system as claimed in claim 13, wherein the auxiliary light emitting unit is formed on the outer circumference of the light emitting unit as a single body.

15. The electrodeless lighting system as claimed in claim 14, wherein the auxiliary light emitting unit is formed in a straight line from the supporting unit.

16. The electrodeless lighting system as claimed in claim 14, wherein the auxiliary light emitting unit is formed within ±180° from the supporting unit.

17. The electrodeless lighting system as claimed in claim 13, wherein the auxiliary light emitting unit is formed in the supporting unit.

18. The electrodeless lighting system as claimed in claim 17, wherein the length of the auxiliary light emitting unit overlaps with the thickness of the reflector.

19. The electrodeless lighting system as claimed in claim 13, wherein the discharge assistant material is Ar.

20. The electrodeless lighting system as claimed in claim 13, wherein a discharge catalyst material for inducing initial discharge of the discharge assistant material is filled in the auxiliary light emitting unit.

21. The electrodeless lighting system as claimed in claim 20, wherein the discharge catalyst material is metal.

22. The electrodeless lighting system as claimed in claim 21, wherein the metal comprises at least one of W, Re, Ta, Ba, Sb, In, Cd, Zn, Ge, As, Tl, Bi, Sc, Ti and Zr.

23. The electrodeless lighting system as claimed in claim 20, wherein the discharge catalyst material is Ne.

24. The electrodeless lighting system as claimed in claim 20, wherein metal and Ne are filled as the discharge catalyst material.
